(19) United States
(12) Patent Application Publication
(10) Pub. No.: US 2004/0010348 A1
(43) Pub. Date: Jan. 15, 2004

(54) Apparatus and method for supplying power to IP system using LAN power of hub

(76) Inventor: Gye-Baeg Lee, Seoul (KR)

Correspondence Address: Robert E. Bushnell, Suite 300, 1522 K Street, N.W., Washington, DC, 20005, US

(21) Appl. No.: 10/183,397

(22) Filed: Jun. 28, 2002

(51) Int. Cl. G06F 15/16; G05D 11/00

(52) U.S. Cl. 700/286; 713/300

(57) ABSTRACT

Disclosed is an apparatus and method for converting a power level of a hub to a power level proper for Internet Protocol (IP) systems and supplying the converted power to the Internet Protocol systems through reversed pins of a connector for the Internet Protocol systems. The apparatus comprises a filter section comprised of a transmission filter and a reception filter, for data exchange with the hub and the Internet Protocol systems; and a direct current-to-direct current (DC/DC) converter for converting a power level of the hub to a power level proper for the Internet Protocol systems. Furthermore, the apparatus comprises a single cable for exchanging both the power and the data between the hub and the Internet Protocol systems.

### BACKGROUND OF THE INVENTION

1. Technical Field

The present invention relates generally to an apparatus supplying power to Internet Protocol (IP) systems using the power of a hub, and more particularly to an apparatus and method supplying power to Internet Protocol systems using the local area network (LAN) power of a hub, wherein both the power and data are provided to the Internet Protocol systems through a single cable.

2. Related Art

Internet Protocol systems are devices that are able to utilize Internet Protocol. Internet Protocol is the network layer for the TCP/IP protocol suite used on Ethernet networks and elsewhere. Transmission Control Protocol (TCP) is the connection-oriented protocol built on top of Internet Protocol. TCP/IP is Transmission Control Protocol over Internet Protocol.

In order to drive Internet Protocol systems such as personal computers, Internet Protocol phones, and other Internet Protocol devices, a local area network system needs cables for exchanging data and power supply devices for driving the Internet Protocol systems. When two or more Internet Protocol systems are connected to a hub in this manner, many cables are required. For example, if there are four people in an office, each person having 2 or more Internet Protocol systems connected to the hub, then at least 16 cables are required. The increase in number of the cables causes an increase in complexity. In addition, as many separate power supply devices as the number of the Internet Protocol systems are required. This is disclosed in detail in Korean patent publication No. 2000-50730, the contents of which are incorporated herein by reference.

I have found that it is inconvenient and undesirable when a large number of cables is required.

### SUMMARY OF THE INVENTION

It is, therefore, an object of the present invention to provide an apparatus and method for converting a power level of a hub to a power level proper for Internet Protocol systems and supplying the converted power to the Internet Protocol systems through reversed pins of a connector for the Internet Protocol systems.

It is another object of the present invention to provide an apparatus for providing both power and data to Internet Protocol systems through a single cable without separate power supply devices thereby to reduce complexity and increase the quality of a call.

To achieve the above and other objects, there is provided an apparatus and method for supplying electric power to Internet Protocol systems using local area network (LAN) power of a hub, and managing data exchange between the hub and the Internet Protocol systems. The method comprises converting power of the hub to a power level proper for the Internet Protocol systems; and providing both the converted power and data to the Internet Protocol systems through a single cable, using reserved pins of a connector for the Internet Protocol systems. The apparatus comprises a filter section comprised of a transmission filter and a reception filter, for data exchange with the hub and the Internet Protocol systems; and a direct current-to-direct current (DC/DC) converter for converting a power level of the hub to a power level proper for the Internet Protocol systems. Further, the apparatus comprises a single cable for exchanging both the power and the data between the hub and the Internet Protocol systems.

To achieve these and other objects in accordance with the principles of the present invention, as embodied and broadly described, the present invention provides a method, comprising: converting power of a hub to a power level of at least one Internet Protocol system; and supplying data and the converted power to the at least one Internet Protocol system through a single cable.

To achieve these and other objects in accordance with the principles of the present invention, as embodied and broadly described, the present invention provides an apparatus, comprising: a hub being connected to a plurality of Internet Protocol systems; a filter section including a transmission filter and a reception filter, said filter section exchanging data between said hub and the plurality of Internet Protocol systems; and a converter converting power of said hub to a power level of the plurality of Internet Protocol systems.

To achieve these and other objects in accordance with the principles of the present invention, as embodied and broadly described, the present invention provides an apparatus, comprising: a hub being connected to a plurality of Internet Protocol systems; a filter section being connected to said hub, said filter section exchanging data between said hub and the plurality of Internet Protocol systems; a converter being connected to said hub, said converter converting power of said hub to a power level of the plurality of Internet Protocol systems, said converter supplying the converted power to the plurality of Internet Protocol systems; and a single cable connecting the plurality of Internet Protocol systems to said filter section and said converter, said single cable conveying the data between said filter section and the Internet Protocol systems, said single cable conveying the converted power to the Internet Protocol systems from said converter.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 illustrates an adapter for providing both power and data from a hub to a plurality of Internet Protocol systems using a single cable, in accordance with the principles of the present invention;

FIG. 2 illustrates a detailed structure of the filter section shown in FIG. 1; and

FIG. 3 illustrates a detailed structure of the DC/DC converter shown in FIG. 1.

### DETAILED DESCRIPTION OF THE PREFERRED EMBODIMENT

While the present invention will be described more fully hereinafter with reference to the accompanying drawings, in which preferred embodiments of the present invention are shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Illustrative embodiments of the invention are described below. In the interest of clarity, not all features of an actual implementation are described. In the following description, well-known functions or constructions are not described in detail since they could obscure the invention with unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure.

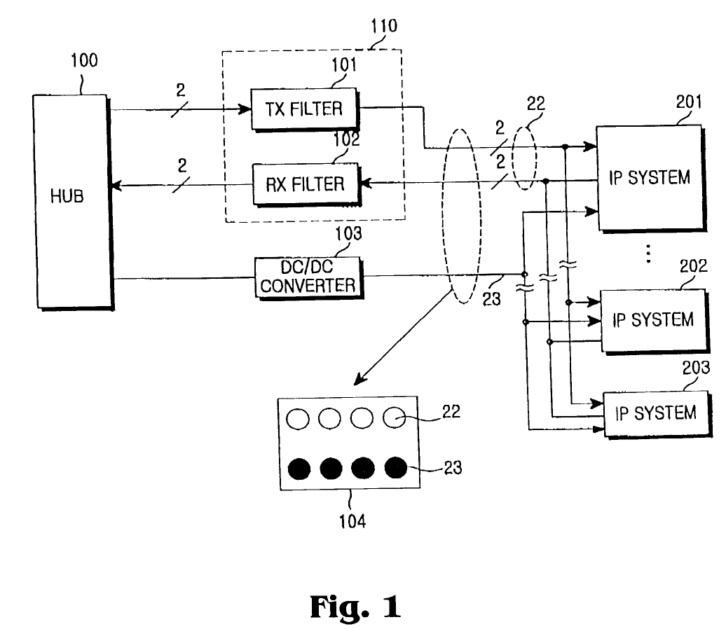

Turn now to FIG. 1, which illustrates an adapter for providing both power and data from a hub to a plurality of Internet Protocol systems using a single cable, in accordance with the principles of the present invention. Referring to FIG. 1, the adapter includes a filter section 110 comprised of a transmission (Tx) filter 101 and a reception (Rx) filter 102 for data exchange with a hub 100 and Internet Protocol systems 201-203, and a direct current-to-direct current (DC/DC) converter 103 for converting power of the hub 100 to a power level proper for the Internet Protocol systems 201-203 and supplying the converted power to the Internet Protocol systems 201-203.

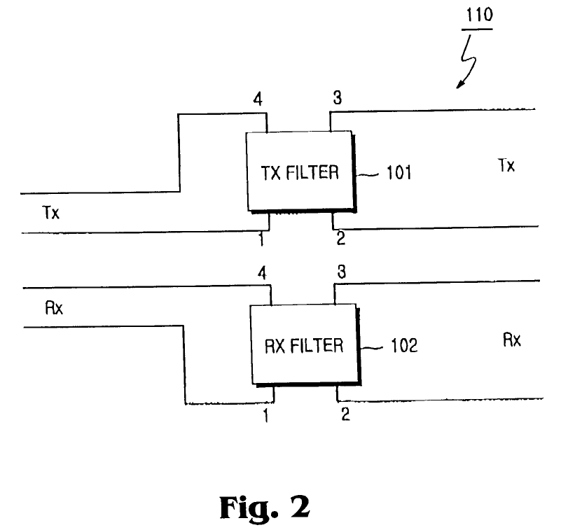

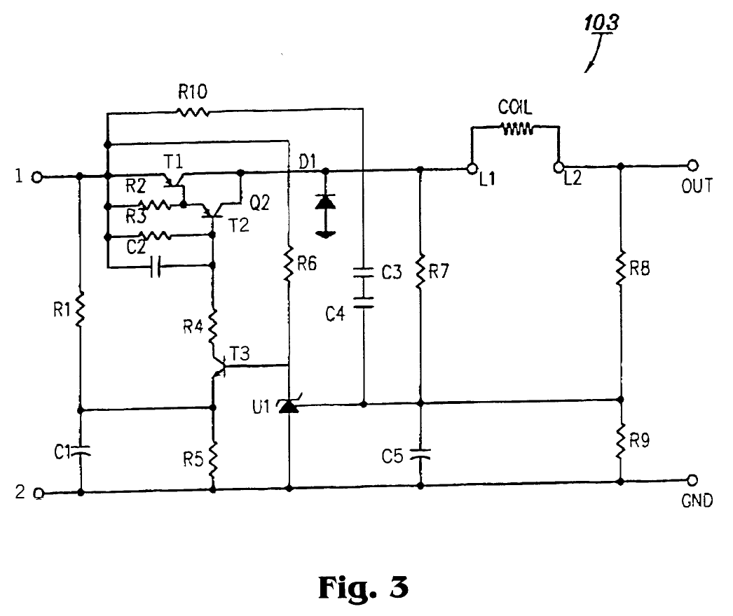

With continued reference to FIG. 1, turn now to FIGS. 2 and 3, which illustrate a detailed structure of the filter section shown in FIG. 1 and a detailed structure of the DC/DC converter shown in FIG. 1, respectively.

A detailed structure of the filter section 110, a line filter, is illustrated in FIG. 2, and a detailed structure of the DC/DC converter 103 is illustrated in FIG. 3. The filter section 110 of FIG. 2 comprised of the transmission filter 101 and the reception filter 102 is available as a model LF4004 filter manufactured by Sunginoon Electronics Co. (SMC), Korea, and the DC/DC converter 103 of FIG. 3 is available as a model DPCDD03 converter manufactured by Daewoo Electronics Co., Korea.

Now, a detailed description of the embodiment of the present invention will be made with reference to FIGS. 1 to 3.

Data exchange between the hub 100 and the Internet Protocol systems 201-203 such as personal computers (PC) and Internet Protocol phones is performed through the transmission filter 101 and the reception filter 102. The Internet Protocol systems 201-203 are supplied with electric power from the hub 100 through power conversion by the DC/DC converter 103, without separate power supply devices.

The FIG. 2 shows transmission filter 101 having four ports 1, 2, 3, and 4. The FIG. 2 shows reception filter 102 having four ports 1, 2, 3, and 4.

The FIG. 3 shows DC/DC converter 103 having an input terminal 1, an input terminal 2, an output terminal (OUT), and a ground terminal (GND). The two input terminals 1 and 2 are separated by resistor R1 and capacitor C1 connected in series. The capacitors C3 and C4 are connected in series. The capacitor C3 is separated from the input terminal 1 by resistor RIO. The capacitor C4 is separated from the ground terminal (GND) by resistor R9. The capacitor C5 is connected in parallel with resistor R9. The output terminal (OUT) and the ground terminal (GND) are separated by the two resistors R8 and R9 connected in series.

The emitter of transistor T1 is connected to input terminal 1. The resistor R2 has two terminals. The first terminal of resistor R2 is connected to the base of transistor Ti. The second terminal of resistor R2 is connected to the input terminal 1. The first terminal of resistor R2 is also connected to the emitter of transistor T2. The collector of transistor T1 is connected to the collector of transistor T2.

The resistor R3 has two terminals. The first terminal of resistor R3 is connected to the base of transistor T2. The second terminal of resistor R3 is connected to the input terminal 1. The capacitor C2 is connected in parallel with resistor R3. The resistor R4 has two terminals. The first terminal of resistor R4 is connected to the base of transistor T2. The second terminal of resistor R4 is connected to the collector of transistor T3.

The resistor R5 has two terminals. The first terminal of resistor R5 is connected to the emitter of transistor T3. The second terminal of resistor R5 is connected to the input terminal 2. The resistor R6 has two terminals. The first terminal of resistor R6 is connected to the base of transistor T3. The second terminal of resistor R6 is connected to the input terminal 1.

The cathode of diode D1 is connected to the collector of transistor T1. The anode of diode D1 is connected to ground. The resistor R7 has two terminals. The first terminal of resistor R7 is connected to the cathode of diode D1. The second terminal of resistor R7 is connected to the capacitor C5, the resistor R9, and the capacitor C4.

In FIG. 3, a coil is connected between the output terminal (OUT) and the cathode of diode D1. The cathode of a zener triode U1 is connected to the base of transistor T3. The anode of zener triode U1 is connected to input terminal 2. The control electrode of zener triode U1 is connected to the second terminal of resistor R7.

Detailed functions and operations of the transmission filter 101 and the reception filter 11 102 show in FIG. 2 and the DC/DC converter 103 shown in FIG. 3 are disclosed in the databooks, so the detailed description thereof will not be provided herein for simplicity and clarity. A highly detailed description regarding the functioning and operations of filters 101 and 102 and of converter 103 are not believed to be needed here, and thus will not be set forth here in order to avoid adding unnecessary complexity to this application.

In a connector 104 of FIG. 1, reference numeral 22 represents data lines and reference numeral 23 represents power lines, so exchange of both the data and the power between the hub 100 and the Internet Protocol systems 201-203 can be achieved with a single cable, thus contributing to a reduction in complexity.

In a hub of a local area network, the hub is supplied with local area network power. That local area network power is converted by converter 103 and then supplied through power lines 23 to the Internet Protocol devices connected to the hub. The local area network power can be needed for the functioning of the hub. It can be ensured that the local area network power supplied to the hub will be sufficient for the functioning of the hub and also for the functioning of the Internet Protocol systems 201-203.

Power can be supplied to the hub from a variety of sources, such as a direct current battery (not shown) or an alternating current power supply (not shown), for example. The data lines 22 and power lines 23 are arranged to form a single cable, in accordance with the principles of the present invention. Reserved pins corresponding to lines 22 and 23 are used, in accordance with the principles of the present invention.

The hub 100 can be a network hub connected to a plurality of computers, for example. Or the hub 100 can be a network hub connected to a plurality of Internet Protocol telephones. Or the hub 100 can be a hub connected to computers, Internet Protocol phones, and other Internet Protocol devices.

If hub 100 receives 12 volts direct current, for example, the hub 100 supplies the 12 volts to DC/DC converter 103. If Internet Protocol system 203 uses 5 volts direct current, for example, then the converter 103 is designed to convert the received 12 volts down to 5 volts, and then to supply the 5 volts to system 203. The 5 volts direct current is supplied to system 203 along a cable connecting the system 203 to the converter 103. The converter 103 is connected between the hub 100 and the system 203. Data is exchanged between system 203 and the hub 100. Basically, one cable connects the hub 100 to the system 203, and that one cable has several different wires 22 and 23 shown in FIG. 1. The wires 22 are used for data exchange and are directed to filter section 110. The wires 23 are used for power supply and are directed to converter 103. In this way, the Internet Protocol system 203 does not need a separate power cable and a separate power outlet. The data and the power are supplied to system 203 from hub 100 using a single cable. The same is true for the other systems 201 and 202.

As described above, the apparatus according to the present invention converts power of the hub to a power level proper for the Internet Protocol systems and supplies the converted power to the Internet Protocol systems through reserved pins of the connector for the Internet Protocol systems. In particular, the apparatus supplies both the power and the data to the Internet Protocol systems using a single cable without separate power supply devices, contributing to a reduction in complexity and an increase in the quality of a call.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit or scope of the applicant's general inventive concept.

What is claimed is:

1. A method, comprising:
converting power of a hub to a power level of at least one Internet Protocol system; and
supplying data and the converted power to the at least one Internet Protocol system through a single cable.

2. The method of claim 1, said supplying being performed through a plurality of pins of a connector for the at least one Internet Protocol system, said single cable being connected to said connector, different ones of said pins being reserved for the data and the converted power, respectively.

3. The method of claim 2, said hub being a local area network hub, the power of the hub being a local area network power.

4. The method of claim 2, the at least one Internet Protocol system being at least one selected from among Internet Protocol computers and Internet Protocol telephones.

5. The method of claim 4, further comprising receiving data from the at least one Internet Protocol system through said single cable.

6. The method of claim 2, further comprising receiving data from the at least one Internet Protocol system through said single cable.

7. The method of claim 6, said converting, supplying, and receiving being performed by said hub.

8. The method of claim 6, said converting being performed by a converter unit located at one position selected from among a first position between said hub and the at least one Internet Protocol system and a second position inside said hub, said supplying and receiving of data being performed by a filter section located at one position selected from among a first position between said hub and the at least one Internet Protocol system and a second position inside said hub.

9. The method of claim 6, the at least one Internet Protocol system corresponding to a plurality of Internet Protocol systems, said single cable supplying the data and the converted power to the plurality of Internet Protocol systems, said single cable receiving the data from the plurality of Internet Protocol systems.

10. The method of claim 9, the at least one Internet Protocol system being at least one selected from among Internet Protocol computers and Internet Protocol telephones.

11. An apparatus, comprising:
a hub being connected to a plurality of Internet Protocol systems;
a filter section including a transmission filter and a reception filter, said filter section exchanging data between said hub and the plurality of Internet Protocol systems; and
a converter converting power of said hub to a power level of the plurality of Internet Protocol systems.

12. The apparatus of claim 11, further comprising a single cable, said single cable performing said exchanging of the data between said hub and the Internet Protocol systems, said single cable supplying the converted power to the Internet Protocol systems.

13. The apparatus of claim 12, said hub corresponding to a local area network hub.

14. The apparatus of claim 13, the plurality of Internet Protocol systems being selected from among Internet Protocol computers and Internet Protocol telephones.

15. The apparatus of claim 12, said converter being located at one position selected from among a first position between said hub and the Internet Protocol systems and a second position inside said hub, said filter section being located at one position selected from among a first position between said hub and the Internet Protocol systems and a second position inside said hub.

16. The apparatus of claim 15, further comprising a connector having a plurality of pins, said connector being disposed between said single cable and the Internet Protocol systems, said single cable being connected to said connector, different ones of said pins being reserved for the data and the converted power, respectively.

17. The apparatus of claim 16, the plurality of Internet Protocol systems being selected from among Internet Protocol computers and Internet Protocol telephones.

18. An apparatus, comprising:
a hub being connected to a plurality of Internet Protocol systems;
a filter section being connected to said hub, said filter section exchanging data between said hub and the plurality of Internet Protocol systems;
a converter being connected to said hub, said converter converting power of said hub to a power level of the plurality of Internet Protocol systems, said converter supplying the converted power to the plurality of Internet Protocol systems; and
a single cable connecting the plurality of Internet Protocol systems to said filter section and said converter, said single cable conveying the data between said filter section and the Internet Protocol systems, said single cable conveying the converted power to the Internet Protocol systems from said converter.

19. The apparatus of claim 18, further comprising a connector having a plurality of pins, said connector being disposed between said single cable and the plurality of Internet Protocol systems, said single cable being connected to said connector, different ones of said pins being reserved for the data and the converted power, respectively.

20. The apparatus of claim 19, the plurality of Internet Protocol systems being selected from among Internet Protocol computers and Internet Protocol telephones.
